(19) United States
(12) Patent Application Publication
(10) Pub. No.: US 2006/0081644 A1
(43) Pub. Date: Apr. 20, 2006

(54) PET SITTER

(75) Inventors: Jennifer J ARNOLD, Alpharetta, GA (US); Kent A. Bruner DVM, Alpharetta, GA (US)

Correspondence Address: SMITH FROHWEIN TEMPEL GREENLEE BLAHA, LLC, P.O. BOX 88148, ATLANTA, GA, 30356, US

(73) Assignee: JOLLYWAGS, INC., Alpharetta, GA (US)

(21) Appl. No.: 11/162,888

(22) Filed: Sep. 27, 2005

Related U.S. Application Data
(60) Provisional application No. 60/620,572, filed on Oct. 20, 2004.

(51) Int. Cl. B67D 5/08; B67D 5/14

(52) U.S. Cl. 222/63

(57) ABSTRACT

A device for dispensing items over a programmable time so treats, toys or other items can be inserted into the dispenser, and then dispensed to pets throughout a period of time. The device can be placed out of reach of pets and then populated with items. A timer is used to actuate a dispensing unit either in intervals of gradually so that the contents are dispensed over a period of time. The device may include audible signal or odor generators to help draw attention when a device is going to be dispensed.

### CROSS-REFERENCE TO RELATED APPLICATIONS

This application claims the benefit of the filing date of U.S. Provisional Application for Patent that was filed on Oct. 20, 2004, having a title of “PET SITTER” and assigned Ser. No. 60/620,572.

### BACKGROUND OF THE INVENTION

The present invention is directed towards an apparatus and method for dispensing treats or toys at preset time intervals and more specifically, it relates to an apparatus and method for programming a fixed or variable time interval at which time, treats or any items are dispensed and thus made available to pets during the absence of an owner or independent from owner activity.

### BRIEF SUMMARY OF THE INVENTION

The present invention provides pet owners a means to dispense items, such as treats or toys, for their pets at preset time intervals, randomly, or pseudo randomly in an automated fashion while the pet owner is away or busy with other tasks. The invention includes various embodiments that allow the user to program the invention either locally or remotely to dispense treats in one of various timing modes. The present invention combines a timer which works in conjunction with a screw mechanism, or other dispensing mechanism, to dispense the items. This allows the user to program fixed or variable time intervals at which time the invention dispenses treats or toys. Alternatively, the system can be set to automatically generate random time intervals for dispensing of the items. The process is fully automated and therefore does not require the user to be present while the invention dispenses treats for the pet. The dispensing mechanism of the invention will be powered by either a mechanical kinetic energy timer or a digital timer which would provide an electrical output to rotate the screw mechanism or actuate the dispensing mechanism. The timer is programmed through various means including the use of manual controls, a local computer interface, as well as remote programming through a network or dial-up connection.

### BRIEF DESCRIPTION OF THE SEVERAL VIEWS OF THE DRAWING

FIG. 1 is an isometric view of one embodiment of the present invention illustrating a housing and a screw dispensing mechanism;

FIG. 2 is a side view of the invention with the timer displayed;

FIG. 3 illustrates the invention in operation;

FIG. 4 illustrates the basic configuration for a LAN connection; and

FIG. 5 illustrates the basic configuration for a dial-up connection.

### DETAILED DESCRIPTION OF THE INVENTION

The pet sitter is designed for a dog or cat but could be adapted for any situation where items need to be dispensed at preset time intervals. In the case of dogs and cats, the invention dispenses treats or toys at fixed, variable, random or pseudo random time intervals.

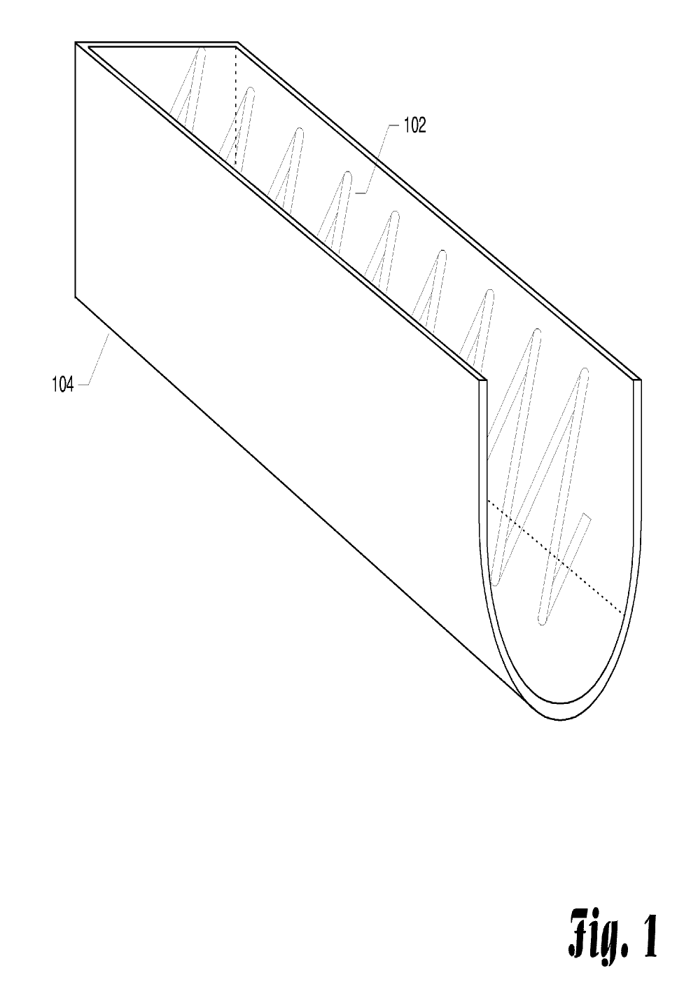

FIG. 1 is an isometric view of an exemplary embodiment of the present invention. The tray or housing or enclosure 104 which houses the screw mechanism 102, or other dispensing mechanism, may be constructed of plastic, wood, metal, or any other material. The housing is preferably constructed in a long, generally rectangle shape. The unit may have a top or in cases where the entire unit is out of the reach of the cat or dog, the top may be removed so that taller items may be placed in the unit to be dispensed. Although the illustrated embodiment utilizes a screw dispenser, it should be appreciated that other dispensing mechanisms may also be used and those skilled in the art will be aware of such technologies, such as advancing slots, rotating plates, rotating gears or the like. The present invention is not limited to any particular dispensing mechanism but, the rotating screw is a simple, elegant and inexpensive dispensing mechanism and thus, is illustrated in conjunction with the description of the various embodiments of the present invention.

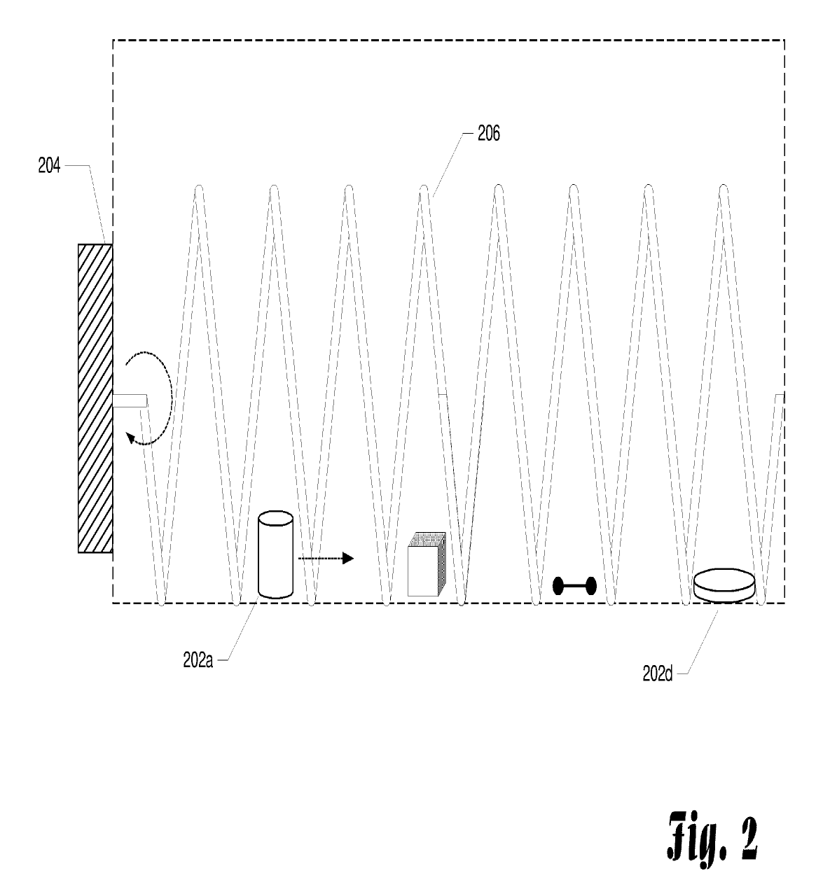

FIG. 2 illustrates the placement of items 202a-d between the coils of dispensing screw 206 ready to be dispensed. The items 202a-d are placed in between the coils of the screw 206 in this illustrated embodiment. Typically, the items will be comprised of toys or treats for the animal. As the screw 206 turns, it pushes the items 202a-d forward. In FIG. 2, item 202d will be the next item in the queue to be dispensed during the next rotation of the screw mechanism 206. The user can adjust the number of items 202a-d that are dispensed as well as the dispensation rate by placing items in only selected slots in the screw or placing multiple items in a single slot. The user may also adjust the dispensation rate by programming the timer 204 for preset intervals. The screw 206 may take on various shapes while the blade of the screw 206 may be flat or stand upright according to the particular application.

One embodiment of the invention involves the use of a mechanical kinetic energy timer. The user manually winds up the timer which can then begin a counting down process. As the timer reaches preset intervals, it operates to release kinetic energy to turn gears which in turn rotates the screw to dispense an item. The timer could also be powered through AC power or a battery. In the case of electrical inputs the timer could be digital. An alternate embodiment of the invention would utilize a digital timer which would provide power to turn the gears in order to rotate the screw.

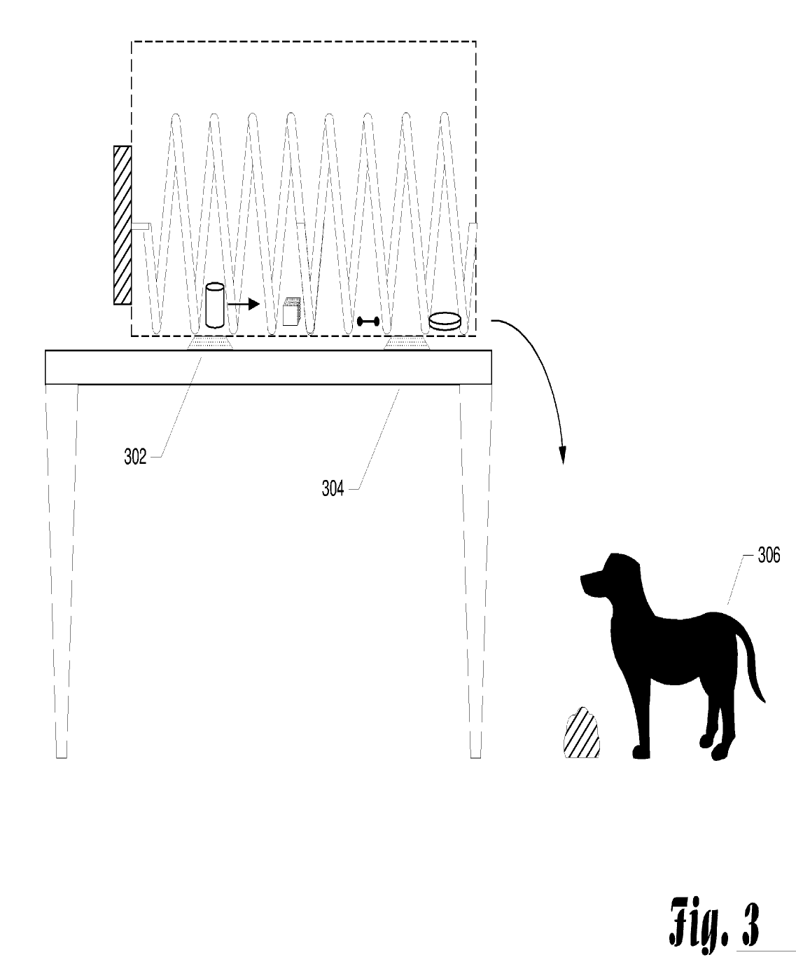

The dispensing device of the present invention is advantageously suitable for hanging on the back of a door, sitting on a counter top, being embedded into a cabinet or box structure, being embedded into a wall, or being hung from the wall. In the back of the door embodiment, the dispensing device hangs off the back of a door by utilizing a hook with wire/string/nylon straps attached to the outside shell. If the invention is not hanging, it can sit on a counter top 304 as illustrated in FIG. 3 with the aid of suction cups 302 or some other apparatus to keep it from slipping if the pet 306 jumps up to pull it to the floor. The dispensing device can also be wall mounted or mounted to the interior of a cabinet with an opening through which the toys or treats are dispensed.

The dispensing device can support multiple modes for programming the timer or a processor that controls or runs the timer. The multiple modes can include a variety of local programming modes and remote programming modes. For remote programming modes, the user can be at another location and control the timer or adjust the timer through remote access. This feature is useful if the user decides to change the interval by which to dispense items, disable further dispensing, retard or delay the further dispensing of items, accelerate the dispensing of items, turn the dispensing device on, etc. For instance, if the user forgets to turn on the invention before leaving home or if the user is delayed at the office, the remote programming feature allows the user to turn on the device.

For local programming, the user can manually set some type of switch (slide switch, DIP switch, etc.) to program the timer or simply wind up the timer in the case of a mechanical kinetic energy timer. An alternate embodiment includes a computer interface (e.g. serial port, USB, or other similar interface) or a keypad interface where the user locally programs the timer through the use of a computer or the keypad. The settings for the timer can also be programmed through the use of a graphical user interface on the computer.

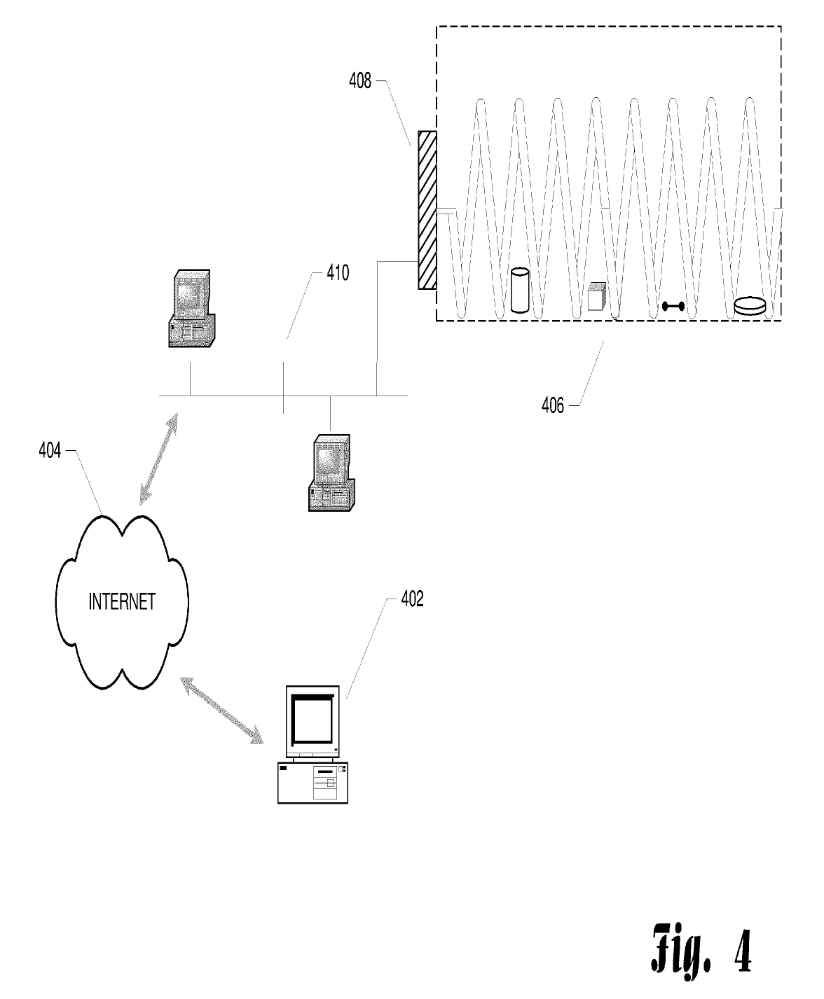

The dispensing device can allow for remote accessibility and programming. One embodiment of the invention 406 may include a network interface to the timer or a timer processor. This aspect of the invention 406 would support interfaces such as an Ethernet, IP or a modem interface. With an Ethernet interface, the timer 408 or a processor that controls the timing aspect of the invention would be connected to some type of local area network (LAN) 410 as illustrated in FIG. 4. In the case of a modem interface, the timer 408 is connected to a phone jack.

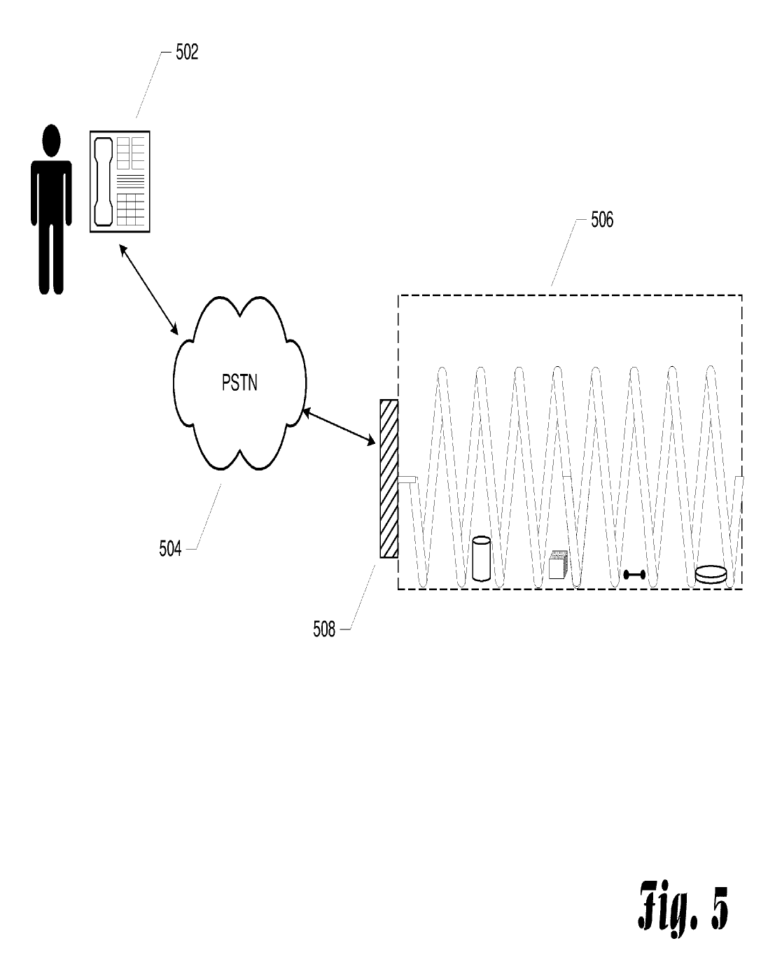

Using the Ethernet, IP or modem interface, a user can establish a connection to the timer processor and then program the timer processor 408 via the Internet 404. This would be achieved through some type of web interface, such as a browser or a proprietary program running on the remote terminal 402. An alternate embodiment of the invention would support a direct dial-up connection into the invention. In this embodiment, the user places a telephone call to a particular number (such as the home number or a dedicated line for the dispensing device). The telephone call is answered by a telephone interface within the dispensing device either automatically or after a predetermined or programmed number of rings as illustrated in FIG. 5. Thus, in an exemplary embodiment the user can simply connect this embodiment of the dispensing device to a jack in the user's home and call home from a phone 502 at a remote site. The telephone interface of the invention goes off-hook to answer the call. This establishes a connection over the Public Switched Telephone Network (PSTN) 504 between the user and the handset being used by the user, and the telephone interface of the dispensing device.

Regardless of the type of interface used to access the timer processor, the timer processor can be programmed by the user. In the direct telephone interface embodiment, the timer processor can be programmed by the user entering a predetermined sequence of DTMF key sequences or, the device can prompt the user to enter particular codes or key presses in response to menu selections. For the predetermined sequence of DTMF signals embodiment, the timer 508 would receive these touch tones and would decode the digits as interval values or interval selections. The invention 506 can send a confirmation tone over the telephone 502 to alert the user that the timer 508 has been programmed. In some instances the user may have to use a pulse dial handset. In this case, the invention includes the ability to decode the sequence of pulses as the user dials in a digit. Again, the invention could send a confirmation tone or pulse sequence to notify the user that the value has been received and programmed. In addition, the embodiment of the present invention could also allow the user to audible speak to the pet through a speaker connected to the telephone call. This advantageously allows the pet owner to directly address the pet, encourage the pet, or summon the pet to the pet dispenser. Similarly, the dispenser could include a microphone that allows the user to hear the pet, such as a bark or meow.

Another alternate embodiment of the invention allows the user to program the timer based on the number of rings detected by the telephone interface of the dispensing device. The user can call the telephone number to which the dispensing device is connected and then, after a certain number of rings, the user can simply hang up. The telephone interface of the dispensing device detects the incoming call and keeps track of the number of rings (i.e., the processor may increment a counter as each ring cycle is detected). The value of the counter would then be used to establish the new time interval. This technique can also be used to simply turn on and off the dispensing device.

The present invention may also include a built-in speaker and an audio playback capability to allow for the playback of sound files or recordings. One advantage of this aspect of the present invention is that it allows for the provision of an audible alert to the pet and indicate that a treat has been dispensed, is being dispensed, or is about to be dispensed. The remote programming capability can include functionality to allow a user to remotely change the selection of the audible alert, create a new message or download new sounds or alerts. In one embodiment, the user can call home on the standard telephone line and the call will be answered by the telephone interface of the dispensing device. The user may then enter a sequence of DTMF signals to place the dispensing device into a recording mode. The user can then recite a message into the mouth piece of the telephone, such as “here boy, want a yummy treat?” which is then recorded. The recording can be ended by either hanging up the telephone or entering a predetermined DTMF signal. The next time a treat is dispensed, the invention plays the user's message to alert the pet.

In an alternative embodiment, the dispensing device may include a plurality of messages that can be programmed for different intervals. In yet another embodiment, a web interface may allow the user to load additional audio files, such as WAV, MPEG or the like, into the device and program the sequence of playback for these messages. Thus, for a multi-dog family, the dispensing device can be programmed to call Rover for a first treat, Spot for a second treat and Skippy for the third treat.

In another embodiment, a message can be programmed into the dispensing device similar to a message in an answering machine. Basically the user can push a record button on the dispensing device and speak into a microphone to record a message.

Another aspect of the invention includes a “feed now” button that can be pressed to automatically advance the dispenser to provide a toy or treat on demand. In addition, a remote control based on RF, infrared or other technology could be used to either program the dispensing device or actuate the “feed now” feature.

Another aspect of the present invention is an aroma emitter. A pet may be more apt to be attracted to the dispensing device if a particular odor is emitted. For instance, to attract a cat, a cat-nip odor can be emitted. To attract a dog, the scent of meat, such as bacon can be emitted.

The dispensing device may also include a display that can be used in conjunction with programming the device, determining a status, or receiving error messages from the device.

Various aspects and features of the present invention have been described and the present invention is not limited to such elements, nor is each of the listed aspects and features required in all embodiments of the present invention.

The present invention provides the user with a means to dispense treats or toys for a pet in an automated fashion at pre-defined intervals. The user may adjust the timer interval and voice message settings locally or remotely. Other embodiments of the present invention can be adapted to provide additional features accessible through remote access. For instance, in one embodiment, the timer may alert the user that all the items have been dispensed and the queue is empty.

What is claimed is:

1. An apparatus for dispensing objects for pets, the apparatus comprising:
a housing that is at least partially enclosed and defines an opening;
a dispensing mechanism located within an interior area of the housing;
an actuator that is operable to actuate the dispensing mechanism automatically and in a controlled manner such that items located within the dispensing mechanism exit the housing through the opening over a period of time.

2. The apparatus of claim 1, wherein the actuator is controlled by a timer.

3. The apparatus of claim 2, wherein the timer is a kinetic energy timer that can be wound by an operator and that operates to release kinetic energy at intervals, the kinetic energy driving the actuator.

4. The apparatus of claim 2, wherein the timer is a digital timer that provides an electrical output at intervals, the electrical output driving the actuator.

5. The apparatus of claim 2, wherein the timer is an electronic timer that provides an electrical signal to drive the actuator at a continuous and slow rate.

6. The apparatus of claim 2, further comprising an audible alert mechanism that can sound to indicate that an item is being dispensed.

7. The apparatus of claim 6, wherein the audible alert mechanism is a speaker, and further comprising a processor provides the timer and is also operative to provide an audio signal to the speaker to indicate that an item is being dispensed.

8. The apparatus of claim 6, wherein the processing unit controls an interface over which the timer can be programmed.

9. The apparatus of claim 8, wherein the interface is a telephone line and the process programs the timer in response to the reception of DTMF signals over the telephone line.

10. The apparatus of claim 9, further comprising an odor emitter that operates to emit a scent near the time that an item is being dispensed.

11. The apparatus of claim 6, further comprising an odor emitter that operates to emit a scent near the time that an item is being dispensed.

12. The apparatus of claim 8, wherein the interface is a telephone line and the process programs the timer in response to the detection of a particular number of ring signals on the telephone line.

13. The apparatus of claim 12, further comprising an interface to a remote control, wherein in response to a signal on the remote control interface, the actuator will operation to actuation the dispensing device to dispense an item.
